(19) United States
(12) Patent Application Publication
(10) Pub. No.: US 2004/0161348 A1
(43) Pub. Date: Aug. 19, 2004

(54) Electric compressor for flammable gas and flammable gas supply system

(76) Inventors: Hirohisa Kato, Kariya-shi (JP); Hidehito Kubo, Kariya-shi (JP)

Correspondence Address: MORGAN & FINNEGAN, L.L.P., 345 Park Avenue, New York, NY, 10154, US

(21) Appl. No.: 10/781,534

(22) Filed: Feb. 17, 2004

(30) Foreign Application Priority Data
Feb. 18, 2003 (JP) 2003-039296

(51) Int. Cl. F02G 3/00

(52) U.S. Cl. 417/410.1

(57) ABSTRACT

An electric compressor for flammable gas has a housing, an electric actuator and a compression unit. The housing has a suction port and a discharge port. An inside portion of the housing serves as a passage for the flammable gas. The electric actuator and the compression unit are sealingly accommodated in the housing, and is driven by the electric actuator. The suction port is located closer to the electric actuator than to the compression unit.

### BACKGROUND OF THE INVENTION

The present invention relates to an electric compressor for compressing flammable gas and to a flammable gas supply system.

In conventional electric compressors used for compressing gas, there have been problems effectively sealing a power transmitting portion arranged between an electric actuator and a compressor. Methods, such as a method for sealing a shaft by a magnet coupling (for example, as disclosed in Unexamined Japanese Patent Publication No. 60-211164) and a method for sealing a shaft by utilizing oil pressure (for example, as disclosed in Unexamined Japanese Utility Model Publication No. 4-116678), have been proposed. Additionally, an electric compressor, which sealingly accommodates an electric actuator and a compressor in a housing and defines a gas passage in the housing, has been proposed (for example, as disclosed in Unexamined Japanese Utility Model Publication No. 1-159185).

However, when implementing a method for sealing a compression chamber through use of a diaphragm, the rate of flow is small in view of compressor body size. The method for sealing a shaft by the magnet coupling is disadvantageous because of increased weight and body size. Additionally, in the method for sealing a shaft by utilizing oil pressure, the control of the oil pressure is complicated and a direction for loading is limited. Furthermore, flammable gas combustion in the electric compressor and a rise in pressure due to the combustion are not considered in every electric compressor conventionally proposed. Therefore, there is a need for providing an electric compressor for flammable gas and a flammable gas supply system, which are appropriate for use with flammable gas.

### SUMMARY OF THE INVENTION

In accordance with the present invention, an electric compressor for flammable gas has a housing, an electric actuator and a compression unit. The housing has a suction port and a discharge port. An inside portion of the housing serves as a passage for the flammable gas. The electric actuator is sealingly accommodated in the housing. The compression unit is also sealingly accommodated in the housing, and is driven by the electric actuator. The suction port is located closer to the electric actuator than to the compression unit.

Other aspects and advantages of the invention will become apparent from the following description, which in conjunction with the accompanying drawings, illustrates by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a schematic view of a hydrogen gas supply system according to a preferred embodiment of the present invention;

FIG. 2 is a schematic cross-sectional view of an electric compressor according to a preferred embodiment of the present invention;

FIG. 3 is a schematic cross-sectional view of an electric compressor according to an alternative embodiment of the present invention; and

FIG. 4 is a schematic view of a hydrogen gas supply system according to an alternative embodiment of the present invention.

### DETAILED DESCRIPTION OF THE PREFERRED EMBODIMENTS

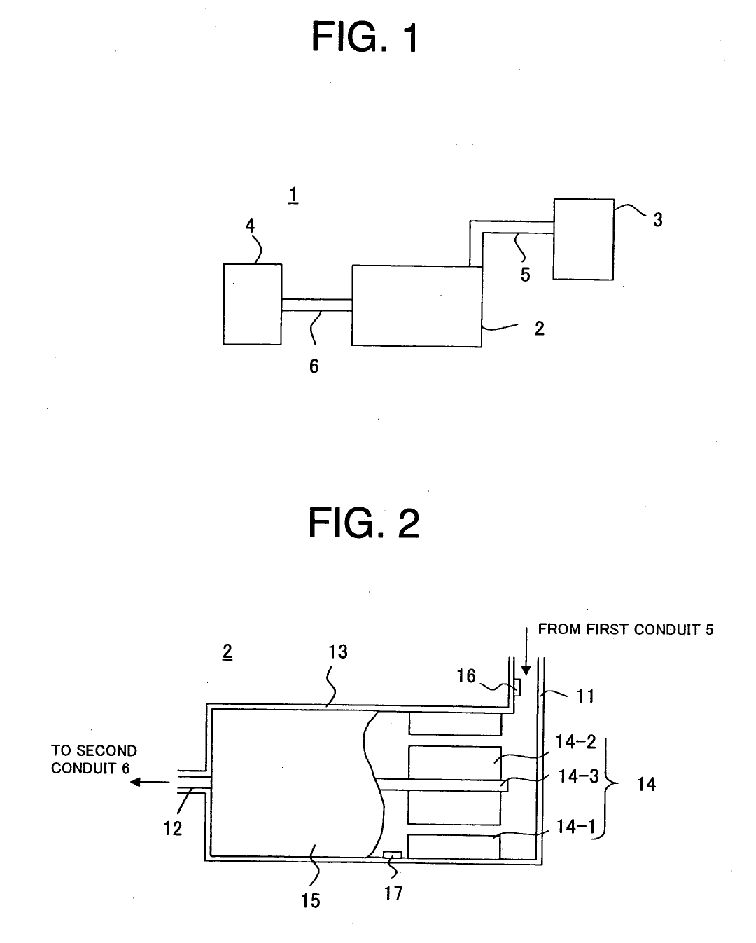

A preferred embodiment of the present invention will now be described with reference to FIGS. 1 through 2. The present invention relates to a system for compressing and supplying hydrogen gas.

As shown in FIG. 1, a hydrogen gas supply system or a flammable gas supply system 1 includes an electric compressor 2, a supply source 3 and a supply target 4. The supply source 3 connects with the electric compressor 2 through a first conduit 5. The electric compressor 2 connects with the supply target 4 through a second conduit 6.

As shown in FIG. 2, the electric compressor 2 includes a suction port 11 for receiving hydrogen gas and a discharge port 12 for delivering hydrogen gas. An electric actuator 14 and a compression unit 15 are sealingly accommodated in a housing 13 of the electric compressor 2. The electric actuator 14 includes a stator 14-1 and a rotor 14-2. The stator 14-1 is arranged on the inner circumferential wall of the housing 13. An output shaft 14-3 is provided at the rotational center of the rotor 14-2 and is supported by a bearing (not shown) that is directly connected to the compression unit 15. The electric actuator 14 is electrically connected to a controller (not shown) and is controlled by the controller. The housing 13 is formed to withstand combustion occurring in the housing 13, which would raise pressure in the housing 13.

The suction port 11 is located on the side of the electric actuator 14 (the right side in FIG. 2) relative to the compression unit 15 of the electric compressor 2. In the preferred embodiment, the suction port 11 is located at an end portion of the electric compressor 2 on the side of the electric actuator 14. On the other hand, the discharge port 12 is located on the side of the compression unit 15. The suction port 11 connects with the first conduit 5, and the discharge port 12 connects with the second conduit 6. Thus, the housing 13 acts as a flow passage for hydrogen gas, which is a flammable gas. The hydrogen gas contains hydrogen as a main component and also contains different component gasses such as oxygen.

The electric compressor 2 further includes two oxygen sensors 16, 17, which serve as gas sensors, and connect with a controller (not shown). The oxygen sensor 16 is arranged in the suction port 11 and detects whether or not oxygen is contained in hydrogen gas that flows into the housing 13. Aditionally, oxygen sensor 17 is arranged in the housing 13 and detects whether or not oxygen is contained in hydrogen gas in the housing 13.

The operation of the above configured preferred embodiment will now be described.

As the supply source 3 begins to supply hydrogen gas, the hydrogen gas flows into the electric compressor 2 through the first conduit 5. The electric actuator 14 is controlled by the controller (not shown) to drive the compression unit 15. The hydrogen gas flowing into the housing 13 through the suction port 11 flows into the compression unit 15 while pushing out gas containing different component gasses such as oxygen and hydrogen gas, which would otherwise tend to stay near the electric actuator 14. Accordingly, pressure in the housing 13 near the electric actuator 14 equals that in the suction port 11 and is higher than atmospheric pressure. Additionally, fresh hydrogen gas is regularly supplied, so that the concentration of hydrogen becomes higher than the explosive limit concentration. The explosive concentration of hydrogen ranges from 4% to 75%, the explosive limit concentration being 75%. When the concentration of hydrogen exceeds 75%, hydrogen does not catch fire.

The compression unit 15 compresses hydrogen gas flowing into it to a predetermined pressure and discharges the hydrogen gas through the discharge port 12. The hydrogen gas discharged from the discharge port 12 is supplied to the supply target 4 through the second conduit 6.

The oxygen sensor 16 monitors the suction port 11 to detect whether or not oxygen is contained in the hydrogen gas, while the oxygen sensor 17 monitors the housing 13 to detect whether or not oxygen is contained in the hydrogen gas. If oxygen is detected by any one of the oxygen sensors 16, 17, the sensors 16, 17 communicate with the controller (not shown) to stop the electric actuator 14.

According to the preferred embodiment, the following advantageous effects are obtained.

(1) The electric actuator 14 and the compression unit 15 are sealingly accommodated in the housing 13, and the inner space of the housing 13 constitutes a passage for hydrogen gas. Accordingly, sealing need not be specifically provided at a portion to transmit power to the compression unit 15. Accordingly, there is no way for hydrogen gas to leak through a sealing portion of a power transmitting portion.

(2) The suction port 11 is located closer to the electric actuator 14 than the compression unit 15 of the electric compressor 2. Hydrogen gas flowing into the housing 13 flows into the compression unit 15 and pushes away hydrogen gas or gas containing different component gas such as oxygen. The replacement gas stays around the electric actuator 14 in the housing 13. Accordingly, since fresh hydrogen gas is regularly supplied to surround the electric actuator 14 in the housing 13, the concentration of hydrogen becomes higher than explosive limit concentration without any control for the concentration of hydrogen, thereby preventing combustion. Additionally, different component gas such as oxygen is prevented from staying around the electric actuator 14 in the housing 13, thereby also preventing combustion.

(3) The suction port 11 is located closer to the electric actuator 14 than to the compression unit 15 and is arranged on the end portion of the electric compressor 2. Thus, the flow of hydrogen gas rarely stagnates around the electric actuator 14 in the housing 13. Accordingly, different component gas such as oxygen is prevented from staying around the electric actuator 14 in the housing 13, thereby preventing combustion.

(4) The suction port 11 is located closer to the electric actuator 14 than the compression unit 15 of the electric compressor 2. Accordingly, pressure of hydrogen gas around the electric actuator 14 in the housing 13 is equal to pressure in the suction port 11, and is lower than the pressure of hydrogen gas compressed by the compression unit 15. Generally, a rise in pressure upon combustion of gas is regularly proportional to pressure of gas before ignition. Accordingly, the housing 13 only requires a relatively low wall strength and a relatively thin wall thickness.

(5) Pressure of hydrogen gas around the electric actuator 14 in the housing 13 is higher than the atmospheric pressure. Accordingly, different component gas such as oxygen do not enter the housing 13 from the outside.

(6) One oxygen sensor 16 is arranged around the suction port 11, and a second oxygen sensor 17 is arranged in the housing 13. Since the electric actuator 14 is a possible ignition point, oxygen contained in hydrogen gas, which contacts with the electric actuator 14, is advantageously detected.

(7) The oxygen sensor 16 monitors the suction port 11 to detect whether or not oxygen is contained in hydrogen gas, while the oxygen sensor 17 monitors the housing 13 to detect whether or not oxygen is contained in hydrogen gas. When oxygen is detected, the oxygen sensor 16 or 17 transmits the detection to the controller (not shown) to stop the electric actuator 14. Accordingly, safety is improved should oxygen flow into the housing 13 for some reason.

The present invention is not limited to the embodiment described above but may be modified into the following alternative embodiments.

In alternative embodiments to the preferred embodiment, the flammable gas is not limited to the hydrogen gas. For example, propane gas and natural gas may be applied.

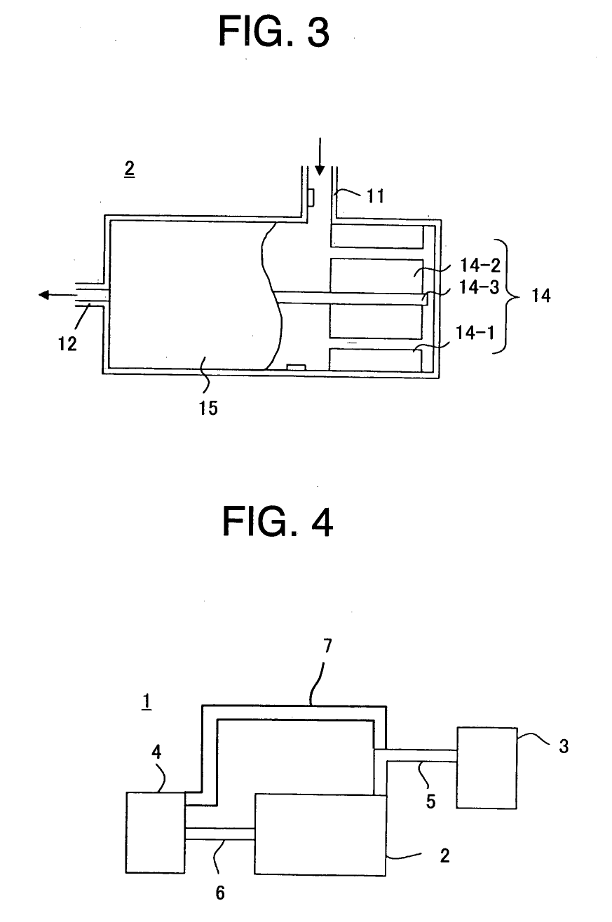

In alternative embodiments to the preferred embodiment, the position of the suction port 11 is not limited to be closer to the electric actuator 14 than to the compression unit 15 of the electric compressor 2, nor is it limited to be at the axial end portion of the electric actuator 14. For example, as shown in FIG. 3, the suction port 11 may be located closer to the electric actuator 14 than the compression unit 5, even if the suction port 11 is located near the middle portion of the electric compressor 2.

In the hydrogen gas supply system 1, the first conduit 5 and the second conduit 6 each form one conduit. In alternative embodiments, the first conduit 5 and the second conduit 6 each are not limited to one conduit. For example, as shown in FIG. 4, a circulation conduit 7 for circulating gas is formed by connecting the supply target 4 to the first conduit 5.

In this state, as hydrogen gas that is partially consumed by the supply target 4 circulates, different component gas other than hydrogen, such as oxygen, tends to be taken into the electric compressor 2. However, according to the present invention, hydrogen gas flowing into the housing 13 flows into the compression unit 15, pushes away hydrogen gas or gas, containing different component gas such as oxygen, and stays around the electric actuator 14 in the housing 13. Thus, different component gas such as oxygen is prevented from staying around the electric actuator 14 in the housing 13. Accordingly, the present invention is appropriate for a flammable gas supply system having a circulation conduit.

In the preferred embodiment, the output shaft 14-3 directly connects with the compression unit 15. In alternative embodiments, for example, the output shaft 14-3 may connect with the compression unit 15 through a gear, a pulley and the like. Anything is applicable provided that power is transmitted.

In alternative embodiments to the preferred embodiment, the oxygen sensor is not limited to serve as a gas sensor for detecting whether or not oxygen exists. For example, a sensor may detect gas other than oxygen. Additionally, a sensor may be a sensor for detecting concentration of hydrogen, which is a main component of flammable hydrogen gas. Furthermore, a combination of the above sensors (the sensor for detecting gas other than oxygen and the sensor for detecting concentration of hydrogen) may be employed.

Therefore, the present examples and embodiments are to be considered as illustrative and not restrictive, and the invention is not to be limited to the details given herein but may be modified within the scope of the appended claims.

What is claimed is:

1. An electric compressor for flammable gas, comprising:
a housing having a suction port and a discharge port, an inside of the housing serving as a passage for the flammable gas;
an electric actuator sealingly accommodated in the housing; and
a compression unit sealingly accommodated in the housing, the compression unit being driven by the electric actuator, wherein the suction port is located closer to the electric actuator than to the compression unit.

2. The electric compressor according to claim 1, further comprising:
a gas sensor provided in at least one of the suction port and the housing.

3. The electric compressor according to claim 2, wherein at least one gas sensor detects the presence of oxygen.

4. The electric compressor according to claim 2, wherein at least one gas sensor serves as a sensor for detecting a concentration of a main component of the flammable gas.

5. The electric compressor according to claim 4, wherein the concentration of the main component exceeds an explosive limit concentration around the electric actuator in the housing.

6. The electric compressor according to claim 5, wherein the flammable gas is hydrogen gas, the hydrogen gas containing more than 75% of hydrogen.

7. The electric compressor according to claim 1, wherein the suction port is located closer to the electric actuator than to the compression unit and is arranged at an end portion of the electric compressor relative to an axial direction of the electric actuator.

8. The electric compressor according to claim 1, wherein the flammable gas is hydrogen gas.

9. A flammable gas supply system comprising:
an electric compressor arranged in a conduit for the flammable gas, the electric compressor including:
a housing having a suction port and a discharge port, an inside of the housing serving as a passage for the flammable gas;
an electric actuator sealingly accommodated in the housing; and
a compression unit sealingly accommodated in the housing, the compression unit being driven by the electric actuator, wherein concentration of the flammable gas in the housing is higher than an explosive limit concentration.

10. The flammable gas supply system according to claim 9, wherein the suction port is located closer to the electric actuator than to the compression unit

11. The flammable gas supply system according to claim 10, wherein the suction port is located closer to the electric actuator than to the compression unit and is arranged at an end portion of the electric compressor relative to an axial direction of the electric actuator.

12. The flammable gas supply system according to claim 9, further comprising:
a gas sensor provided in at least one of the suction port and the housing.

13. The flammable gas supply system according to claim 12, wherein at least one gas sensor detects the presence of oxygen.

14. The flammable gas supply system according to claim 12, wherein at least one gas sensor serves as a sensor for detecting a concentration of a main component of the flammable gas.

15. The flammable gas supply system according to claim 12, wherein the flammable gas is hydrogen gas.

16. The flammable gas supply system according to claim 12, wherein the conduit includes a circulation conduit, whereby the flammable gas circulates to flow into the electric compressor.
